(19) United States
(12) Patent Application Publication
(10) Pub. No.: US 2013/0339969 A1
(43) Pub. Date: Dec. 19, 2013

(54) Scheduling and Decision System

(71) Applicants: Christine L. Koski, Dallas, TX (US); Lucille K. Hoger, Houston, TX (US); WIlliam N. Turley, Costa Mesa, CA (US); Ryan C. Heaton, Castle Rock, CO (US)

(72) Inventors: Christine L. Koski, Dallas, TX (US); Lucille K. Hoger, Houston, TX (US); WIlliam N. Turley, Costa Mesa, CA (US); Ryan C. Heaton, Castle Rock, CO (US)

(73) Assignee: NMETRIC, LLC, Costa Mesa, CA (US)

(21) Appl. No.: 13/563,329

(22) Filed: Jul. 31, 2012

Related U.S. Application Data
(60) Provisional application No. 61/661,635, filed on Jun. 19, 2012.

(51) Int. Cl. G06F 9/50

(52) U.S. Cl. 718/103; 718/104

(57) ABSTRACT

A task-centered scheduling system is disclosed, whereupon a manager could schedule a task with a number of attributes for resources (such as persons, types of rooms, tools, machinery, ingredients, etc.). The system then matches resources with the task so that the task could be completed. For example, if a manager schedules a task for a person with cleaning skills to clean a dirty room with a mop and a bucket with soap, the scheduler will find an available person with cleaning skills, allocate the mop and bucket to that available person, and send that available person to the dirty room to clean it. The system keeps track of the resources in order to know what resources are available for allocating to a task, and different tasks may have different priorities which could cause lower priority tasks to be rescheduled in favor of higher priority tasks.

This application claims priority to U.S. provisional application having Ser. No. 61/661,635 filed on Jun. 19, 2012. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is scheduling system.

### BACKGROUND

When a company has a series of tasks that need to be completed, a manager typically allocates employees towards each task. Computer scheduling systems, for example Microsoft Outlook®, can be helpful to visualize such schedules. For example, a manager could use a computer scheduling system to block off specific times of the day for employees to perform certain tasks, and assign specific employees to that task. Each employee would then have a calendar of tasks to do throughout each day, week, and month, which could be easily visualized and organized. In order for a manager to assign specific employees to each task, however, the manager needs to manually track each employee's schedule and allocate each employee to the appropriate task.

US2009/0315735 to Bhavani teaches a computer system for managing patient flow in a hospital, where a manager could tag specific patients, medical employees, and resources with RFID chips to determine where each patient, employee, and resource is, and allocate each resource accordingly as needed. For example, if there are too many patients waiting for an examination room, a patient could be automatically relocated to an examination room with a shorter line by sending a message to an available employee to redirect that patient. Bhavani, however, requires the system to manually track each patient, employee, and resource by a unique identifier.

U.S. Pat. No. 7,587,329 to Thompson teaches a computer system for managing a health clinic, where a manager could input a series of attributes into a computer that an on-duty nurse needs to have to accomplish a specific task. The system then matches available nurses with those requirements with the task in order to accomplish the task, and can send out schedules to each nurse, letting that nurse know what tasks to perform. Thompson's computer system, however, fails to enable a manager to input a series of attributes for resources, such as patient requirements for operating rooms, intensive care unit beds, or heart rate monitor machines.

Bhavani, Thompson, and all other extrinsic materials discussed herein are incorporated by reference to the same extent as if each individual extrinsic material was specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved scheduling systems.

### SUMMARY OF THE INVENTION

A task-orientated computer system allows a manager to calendar tasks that involve resources (e.g., people, equipment, tools, rooms, virtual rooms, computers, etc) by focusing on the attributes of the tasks and resources, rather than the just the resources themselves.

Among other things, the inventive subject matter provides apparatus, systems, and methods in which one can schedule an initial task with respect to non-unique attributes of a plurality of resources. As used herein, a “resource” is any resource, whether physical or virtual, living or nonliving. Examples include a room, a building, a consumable item, a portable tool, a piece of equipment that is fixed to a location, a person, or an animal. Each resource typically has a series of unique and non-unique attributes that are associated with the resource. As the terms imply, unique attributes are attributes that are unique to that particular resource, and non-unique attributes are attributes that can be common by more than one resource.

Various resources, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a method of scheduling a task.

FIG. 2 is a schematic of another method of scheduling a task.

FIG. 3 is a schematic of additional steps that can be used in combination with the methods of FIG. 1 and FIG. 2.

FIG. 4 is a schematic of one embodiment of a computer system for scheduling a task.

FIG. 5 is a schematic of another embodiment of a computer system for scheduling a task.

FIG. 6 is a schematic of another embodiment of a computer system for scheduling a task.

### DETAILED DESCRIPTION

It should be noted that while the following description is drawn to a computer-based scheduling system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including facilitating the scheduling of events.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

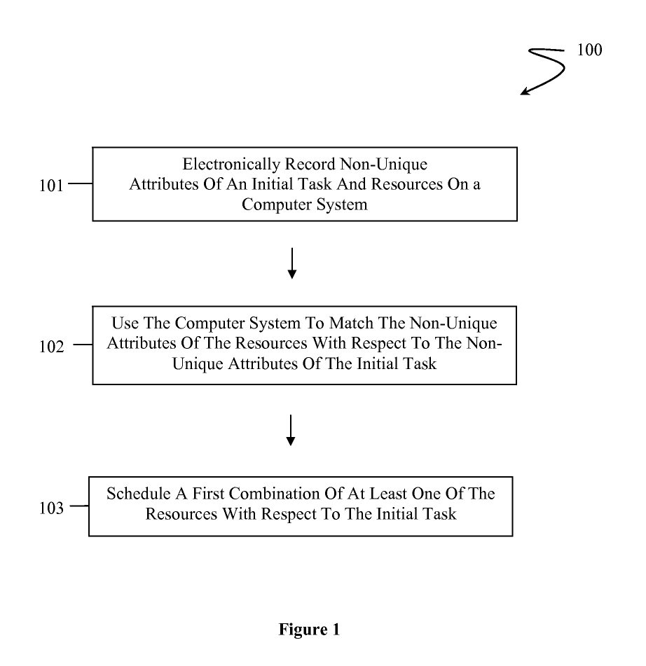

FIG. 1 shows a schematic of a method of scheduling an initial task 100. Step 101 comprises electronically recording non-unique attributes of an initial task and a plurality of resources. Step 102 comprises using a computer system to match non-unique attributes of the resources with respect to the non-unique attributes of the initial task. Step 103 comprises scheduling a first combination of at least one of the plurality of resources with respect to the initial task.

As used herein “non-unique attributes” means attributes that can be shared by more than one resource. Examples of unique attributes could be, for example, a UID (Unique Identifier), a name, a social security number, a thumbprint, a serial number, or an address. Examples of non-unique attributes could be, for example, available time periods, preferred tasks that the person or the resource should be associated with, a non-unique corporate title, a skill, a skill level, a capability, preferred resources that a person should work with, preferred unique coworkers that a person should work with, a category of a resource, or a location of the resource. It is possible that an attribute could be unique in one context and non-unique in another context. For example, an employee address could be non-unique if there are two or more employees with the same address.

Examples of non-unique attributes for a task may include, but are not limited to, a person with a set of non-unique attributes, a resource with a set of non-unique attributes, a length of time, a subsequent task, and/or a preparatory task. Examples of non-unique attributes for a person may include, but are not limited to, a corporate title, a skill, a skill level, a capability, a resource preference, a task preference, a coworker preference, and/or an available time period. Examples of non-unique attributes for non-human resources (e.g., materials, consumable items, fixed equipment, mobile tools, rooms, buildings, computers, projectors, phones) may include, but are not limited to, quantity, quality, capability, availability, type, cost, location, and/or life cycle.

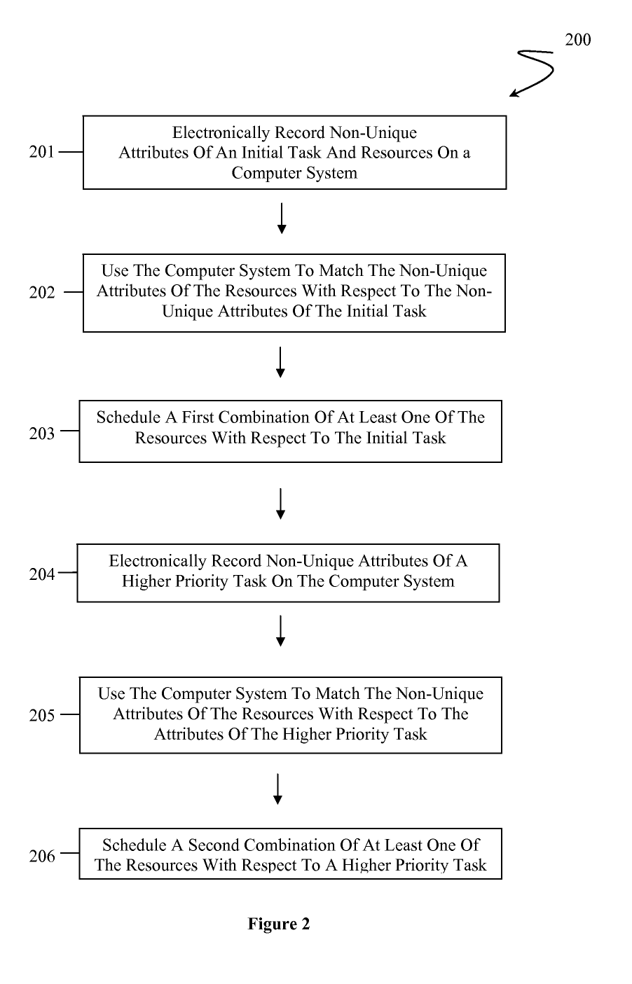

FIG. 2 shows a schematic of a method of scheduling an initial task 200. In method 200, steps 201, 202 and 203 are identical to steps 101, 102, and 103 in method 100, respectively. In addition, method 200 includes steps 204, 205, and 206. Step 204 comprises electronically recording non-unique attributes of a higher priority task on the computer system. Step 205 comprises using the computer system to match the non-unique attributes of the resources with respect to the higher priority task. Step 206 comprises scheduling a second combination of at least one of the resources with respect to the higher priority task. In method 200, the second combination can conflict with the first combination.

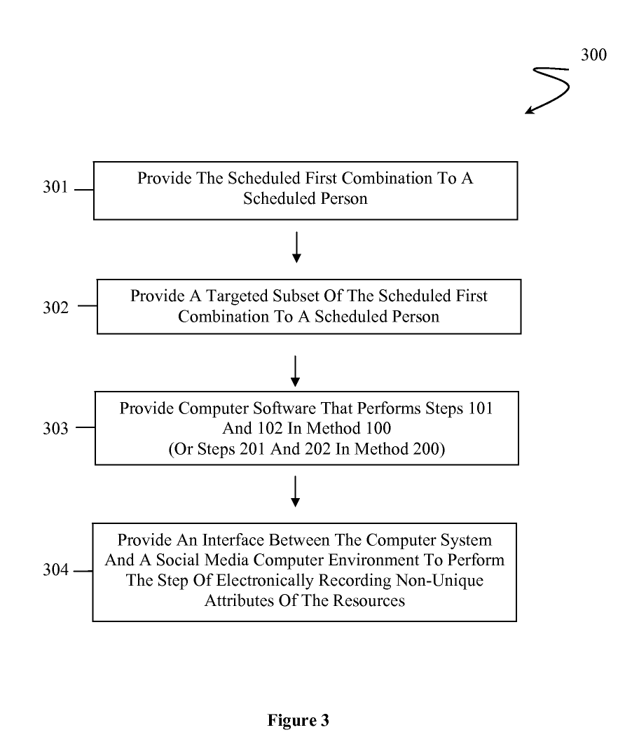

FIG. 3 shows a method 300 that includes steps 301-305. Steps 301-305 are intended to be used with method 100 and/or method 200. Each of steps 301-305 can be used independently with method 100 and/or method 200, or in combination with some or all of the remaining steps 301-305.

Step 301 comprises providing the scheduled first combination to at least one scheduled person. Step 302 comprises providing a targeted subset of the scheduled first combination to a scheduled person. Step 303 comprises providing computer software that performs steps 101 and 103 in method 100 or, alternatively, steps 201 and 202 in method 200. Step 304 comprises providing an interface between the computer system and a social media computer environment to perform the step of electronically recording non-unique attributes of the resources.

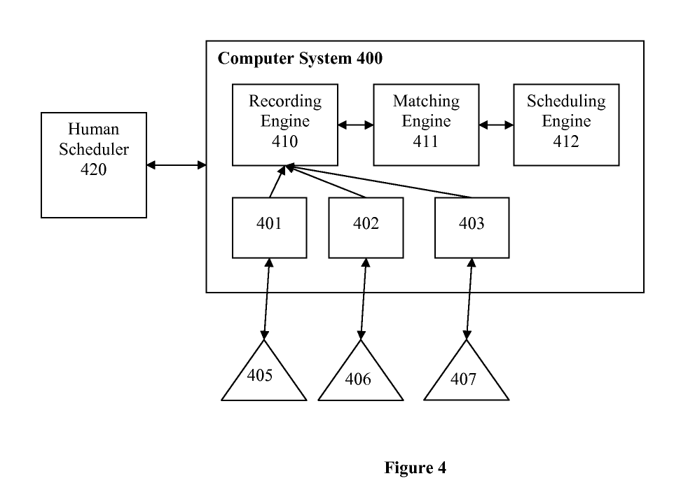

FIG. 4 shows a computer system 400. Computer systems are well known and generally comprise a processor, electronic storage medium, and executable code.

System 400 has three separate and distinct physical environments 401, 402, and 403 that allow a user to interface with system 400 for the purposes of inputting unique and non-unique attributes 405, 406, and 407, respectively. Attributes 405 correspond to an initial task 405. Attributes 406 correspond to resources. Attributes 407 correspond to a higher priority task. Physical environments 401, 402, and 403 could comprise a user interface for a computer system, such as keyboards, cameras, mice, or any other device suitable for receiving information.

System 400 has a recording engine 410 for recording attributes 405, 406, and 407 in an electronic storage medium (e.g., a database, hard drive, etc). System 400 also has a matching engine 411 that matches the non-unique attributes of resources 406 with respect to non-unique attributes of initial task 405. Once the matching has been performed, scheduling engine 412 schedules a first combination of at least one of the persons and resources with respect to the initial task.

As used herein, “engine” refers to computer processing hardware and software that are configured to perform a particular function. The engines described above can comprise one processor and one set of software that includes code for achieving the desired roles and responsibilities of each engine. Alternatively, the engines described above can comprise three separate processors and three separate sets of executable software code for performing the desired functionality. Those of skill in the art will appreciate that numerous hardware and software configurations can be used without departing from the inventive concepts. The engines described above could even rely on external computing devices to perform their various roles (e.g., virtual processing, virtual databases storage, distributed computing, etc).

Human scheduler 420 can interact with one or more physical environments of the system (e.g., environments 401-403) to input unique and/or non-unique attributes of each task, resource, and person into the system (attributes 405-407). Alternatively, human scheduler 420 could import attributes from any data repository, such as a database, remote storage facility, or CSV file.

Once human scheduler 420 has input necessary or preferred attributes of a task, the scheduling engine 412 generates one or more combinations of resources to that task by matching attributes of resources with resources that have those necessary and/or preferred attributes.

Human scheduler 420 can reiterate the steps above using system 400 to schedule subsequent tasks. Subsequent and preparatory tasks could be assigned to the initial scheduled task in order to create dependencies that cascade throughout a schedule. Since different tasks may have different priorities, a higher priority task (having attributes 407) that is scheduled at a later date could supersede previously allocated persons and resources in such a way that a cascade of tasks, and thus persons and resources, may need to be reallocated.

Once engine 412 has scheduled a task, system 400 can provide the schedule to designated people within an organization. For example, system 400 could include an interface for displaying scheduled tasks (not shown). System 400 could also send the scheduled tasks to an external device, such as a server, smart phone, laptop computer, or desktop computer. The scheduled tasks may be delivered in printed form or electronically (e.g., via email or an electronic calendar).

System 400 also allows scheduled tasks to be listed or displayed in different formats. For example, scheduled tasks may be listed by task (e.g., listing the resources allocated to each task), by person (e.g., listing the tasks and resources allocated to each person), by room, by tool, by date, or by any other resource or task attribute (e.g., listing the tasks and resources responsible for that resource).

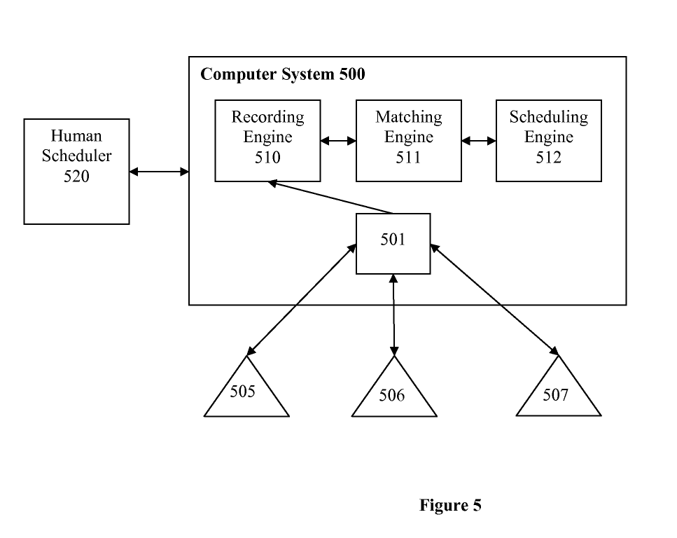

FIG. 5 shows a computer system 500. System 500 is similar to system 400 except that physical environments 401, 402, and 403 have been replaced with one physical environment 501. Environment 501 is a single user interface that allows a user to record attributes 505, 506, and 507.

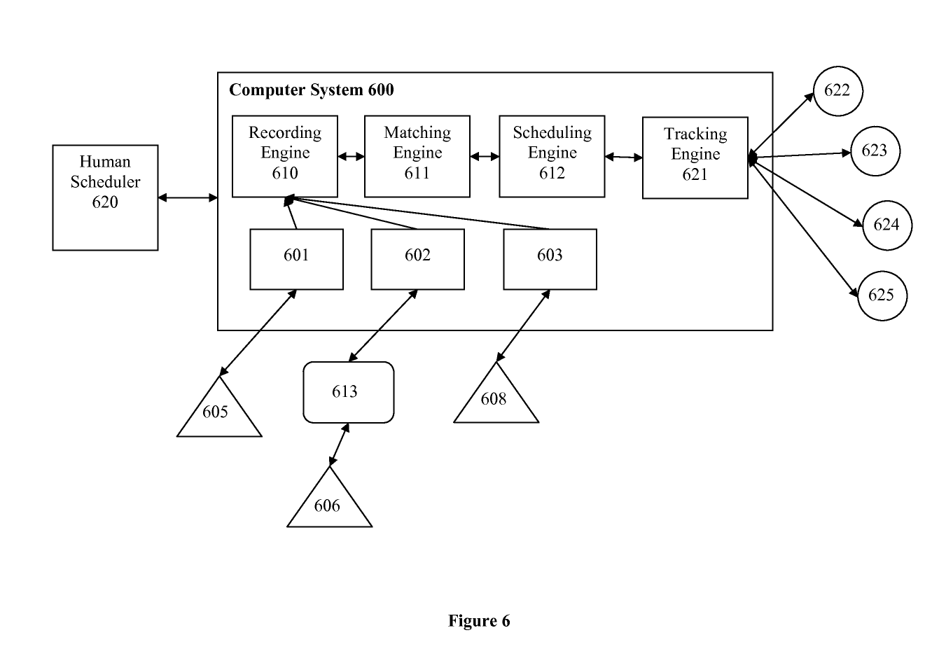

FIG. 6 shows a computer system 600. System 600 is similar to system 400 except that physical environment 602 interfaces with social media computer environment 613 for receiving and recording non-unique attributes of resources 606. Environments 613 can be one distinct environment or a combination of multiple environments (e.g., two different websites, two different web servers, two different service providers). As used herein, a “social media computer environment” is an electronically based community.

System 600 can be useful for scheduling tasks among internet-based social and professional communities that have limited information about one another. The community host (e.g., server provider) could provide an applet (e.g., software code and interface) that allows users to schedule a community service event (i.e., a “task”) that requires people of certain skills, locations of certain price ranges, tools, and equipment that could be allocated to the event, and consumable items to be donated. Once these attributes are posted to the applet, the applet could then match users having those attributes and/or who control resources of those attributes and schedule the event.

System 600 also differs from system 400 in that it has a tracking engine 621. Engine 621 tracks the location of RFID signals 622, 623, 624, and 625, which are placed on persons and mobile resources. For example, RFID tags can be placed on employees, laptops, smart phones, and medical portable medical equipment to track the location of the resources as they are used during a scheduled task. Tracking engine 621 could also track signals from sensors, for example, acoustic sensors (e.g., voice commands), heat sensors (e.g., heat signature patterns), motion sensors, pressure sensors, to determine the location or presence of a resource. Tracking engine 621 can communicate with engines 610, 611, and 612 so that the location of persons and resources can be used to schedule a task.

Engine 621 is also configured to receive tracking data that has been inputted manually by a user. For example, a user can communicate engine 621 via a computer, web-portal interface, smart phone applet, or any other suitable method and device for manually entering data. The user can manually track the status of tasks and the location of resources and input the data into engine 621 for analysis. Engine 621 can be configured to reschedule tasks automatically if tasks are not completed according to assignment.

The numerous advantages of the methods and systems described above can be further illustrated by way of working examples.

### Working Example #1

An administrator at a large hospital needs to schedule an open heart surgery, more specifically, an aortic valve replacement (i.e., the “task”) for a patient that recently suffered a heart attack. The surgery requires one heart surgeon, one anesthesiologist, and at least three medical support staff, which include a surgical assistant, an equipment monitoring assistant, and a junior surgeon. The surgery also requires an operating room that can accommodate the size of the medical team during the four hour surgery, and that has the necessary equipment, tools, and consumables (e.g., human valve donor or a mechanical valve, blood transfusion machine, sufficient volume of blood for the transfusion, heart rate monitor, defibrillator, endoscopic video camera, surgical knives and other surgical tools, disinfectants, gauze, etc).

The administrator can use the inventive methods and systems described herein to efficiently schedule the surgery. The administrator enters the task attributes into computer system 400. The task attributes, which are selected by the administrator, can include an urgency level, a specific date for the surgery, a “no-later-than” date for the surgery, the desired attributes of the necessary persons (e.g., type of surgeon, skill/experience level of the surgeon and staff, etc), and any other resources relevant to the task (e.g., heart donor, blood transfer, etc). Once the administrator has entered the task attributes into system 400, recording engine 410 stores the task attributes in an electronic storage medium within system 400. Matching engine 411 then compares the task attributes with resource attributes (e.g., availability of doctors and other medical staff, location of people and equipment, doctor skill level, doctor expertise, doctor experience, co-worker preference, resource preference, availability of a room, availability of equipment and tools, size of room) already stored in system 400. Finally, scheduling engine 412 schedules the task by generating a combination of “preferred” resources that best satisfy the task attributes. As used herein, a “preferred resource” is a resource that matches with attributes of the task, but is not necessary for the task to be complete.

Unlike the presently described scheduling system, conventional scheduling systems would merely compare availability of specific resources (i.e., specific people and specific resources), as for example availability of a specific surgeon or a particular heart valve. It would be up to the human administrator to determine the task requirements and what specific resources meet those requirements. In doing so, availability is treated as a preference or requirement.

In contrast, system 400 accesses a preloaded database to automatically determine the attributes needed to accomplish the task (task preferences and requirements), and then automatically determines what specific resources are available to satisfy those task attributes. Availability of resource is merely one of many different resource attributes and can be treated as either a preference or requirement.

In one aspect, system 400 advantageously allows the administrator to rank task attributes by level of importance. For example, the administrator may wish to rank the date of the surgery as a higher importance than the availability of a particular piece of equipment. The flexibility provided by system 400 eases the administrator's burden of allocating resources in a complex organization such as a large hospital.

In another aspect, system 400 allows the administrator to create dependencies between different, yet related tasks. For example, the heart surgery patient may have multiple tasks that need to be performed before and after surgery (e.g., fasting before the surgery, allocating a clean-up crew for the surgery theatre, or a post-op recovery room for the patient). The existence of dependencies between different tasks can be inputted into system 400 as a task attribute of the present task to ensure that all related resources are available before scheduling the present task.

System 400 also allows the administrator to rank tasks according to a level of urgency. As used herein, the concept of ranking tasks is conceptually different from ranking task attributes. For example, the administrator may wish to assign an elective surgery a low urgency and an emergency surgery a high urgency, to ensure that system 400 gives the emergency surgery priority to the resources. System 400 can even be used to cancel tasks, when a higher importance task needs to be scheduled. For example, an emergency surgery (i.e., a “high priority task”) for an emergency room (“ER”) patient may supersede a previously scheduled elective surgery (i.e., a “low priority task”), causing a cascade effect that may delay the elective surgery a few hours or even a few days.

In yet another aspect, system 400 can be used to take into account patient preferences. For example, the patient may wish to exclude students from observing the surgery and may wish to wait for a human valve rather than a mechanical valve. These preferences can be entered into system 400 as task attributes.

### Working Example #2

A partner at an intellectual property law firm would like to schedule a brainstorming session to develop additional patentable concepts for a large corporation client. The brain-storming session requires the presence of the partner, a paralegal, and at least one other patent attorney who (a) has previously worked with the client and (b) has a chemical engineering background. From the client's side, the brainstorming session requires a business/marketing person, one in-house patent attorney, a high-level decision maker, and at least two chemical processing engineers. The duration of the brainstorming session is estimated at four to eight hours. The location of the session can occur at either the law firm's offices or the client's offices. The room must include a white board, a laptop and a projector, a window with a decent view. The room preferably has blue tones with red as a secondary color. The size of the room is preferably twice the size of the group.

In this case the task attributes of a “brainstorming session” would likely not be preloaded into the database. Consequently, the law firm's office manager (or someone else) manually enters the task attributes within system 400. That person may then chose to categorize some attributes as “preferred” attributes (i.e., not mandatory) and others as “essential” (i.e., the task will not be scheduled until those attributes are matched/satisfied).

System 400 physically resides at the law firm. However, system 400 is configured to communicate with a similar system and/or database that is physically located at the client's office, and which contains resource attributes associated with the client. System 400 automatically compares the task attributes with attributes of the available resources from both the law firm and the client, and when sufficient matches are made, system 400 goes on to schedule the task using the appropriate resources.

System 400 also allows the office manager to create and enter group attributes to create a preference for a diversified group of persons and/or resources. Examples of such attributes could include gender, age, residence, education, work experience, personality type, etc. of the desired group (e.g., “group must have at least one person below the age of 30 and one person above the age of 60” or “group must be all males”).

Working example #2 illustrates how the inventive methods and systems described herein go way beyond coordinating the availability of specific people or resources. Rather, system 400 allows the office manager to schedule a productive brainstorming session by organizing a diverse group of people and placing those people in a creative, collaborative, and positive atmosphere. System 400 also allows the scheduler to define group attributes in addition to task attributes.

### Working Example #3

A construction manager is overseeing a large multi-billion dollar power plant construction project. The construction manager must interact with architectures, civil engineers, government inspectors, tradesman (e.g., framers, concrete workers, electricians, painters), raw materials suppliers, and transportation service providers. Each phase of the construction project has multiple dependencies on previous phases and requires the constant monitoring of availability of resources (e.g., workers, raw materials) to ensure that the deadline is met.

The construction manager has a team of human schedulers in charge of maintaining and updating a database of resource attributes in system 400. Some of the human schedulers are responsible for checking the daily progress of tradesman and updating the database accordingly (e.g., availability of tradesman, status of phases, etc). Other human schedulers track the location of raw materials that are in shipment, estimate arrival dates, and assign probabilities and confidence levels to the arrival dates. Yet other human schedulers monitor inventory of materials and update the database daily. Other schedulers are in charge of identifying tasks and inputting task attributes into system 400. Some schedulers may also be responsible for manually inputting the status of a task (e.g., completed, pending, 30% complete, etc). The schedulers input and/or monitor resource and task attributes via a web browser and mobile device apps. For example, the schedulers responsible for updating the status of tasks may have mobile devices with apps that allow the schedulers to roam throughout the construction site and update the database onsite.

The construction manager, either personally or via delegation, uses system 400 to monitor the construction project, schedule tasks, and allocate resources. System 400 allows the construction manager to schedule a task while taking into account numerous interdependencies.

In this example, the difficulty is not focused so much on the skill level of the workers (as in the hospital example), or getting asset/attribute information from different databases (as in the law firm example), but on the availability of equipment and raw materials that are typically brought to a construction site on a just in time basis. For example, there may be a need for concrete, rebar and concrete mixers and pumping trucks to lay the foundation. And the rest of the facility cannot be built until the foundation is complete. If the concrete is available but not the rebar, or both concrete and rebar are available but not the pumping trucks, the construction stops.

In this case the construction project would be viewed as a sequence of tasks, with some of the tasks dependent upon completion of other tasks. System 400 accounts for these dependencies, by viewing the dependencies as attributes when matching task attributes (requirements) with assets. System 400 has preset rules for handling dependencies and conflicts and can even reschedule tasks per the preset rules. System 400 is also capable of communicating with third party databases (vendors, raw materials suppliers, subcontractors, etc) to determine the “universe” of available resources.

Not only is system 400 useful for allocating resources within the current project, but can allocate resources among different projects. For example, the construction manager may also be overseeing another construction project, such as an offshore windmill construction project. In constructing offshore windmills, the construction manager must lease cargo ships to transport building materials (steel, concrete, etc). If the ships are leased on a quarterly basis (i.e., 3 months at a time), but only 4 months are needed to build the windmills, system 400 could be used to allocate the remaining 2 months of a two-quarter lease to transport materials or people for the power plant project.

### Working Example #4

Allocation of workers in a large insurance company illustrates yet other points. For example, a insurance company A has thousands of workers spread out in numerous offices around the country. Company A lands a large contract to provide guidance to the California state government regarding a medical benefits package, and needs to re-allocate its resources to Sacramento to complete the project.

In this case the overall task might have numerous subtasks (which could be viewed as dependent tasks), each of which requires managers, systems engineers, programmers, instruction manual writers, lawyers, and so forth. Yet due to family commitments, geographic preferences, prior allocation to other projects, and other factors, people who meet those task attributes (requirements) are not as readily moveable as a piece of equipment. System 400 would nevertheless automatically compare the task attributes against one or more resource databases to produce the best possible match. Specifically, system 400 includes resource attributes that represent employee preferences with respect to traveling and relocating.

The working examples provided above are included merely as non-limiting examples. Those of ordinary skill in the art will appreciate that the inventive subject matter described herein can be applied to numerous industries and situations for improving the scheduling of persons and/or resources with respect to a task.

In other working examples the scheduling system is used to schedule tasks that merely require people and not tools, equipment, or other non-human resources. In yet other examples, the scheduling system is used to monitor physical resources other than people. In addition, some working examples may involve tasks that do not require any physical location (e.g., conference room), rather, the tasks may be performed at a virtual location (e.g., conference call-in number, video conference call,). Many applications of the scheduling systems and methods disclosed herein can be used consistently without departing from the inventive concepts.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A method of using a computer system having a processor and a memory to assist a human scheduler in scheduling a task with respect to first, second, and third resources, comprising:
electronically recording:
(a) a first set of task attributes corresponding to a first requirement of the initial task;
(b) a second set of task attributes corresponding to a second requirement of the initial task; and
(c) first, second, and third sets of resource attributes corresponding to the first, second, and third resources;
the computer system producing a proposed schedule that automatically selects the first and second resources for inclusion in the schedule by matching the first set of task attributes with the first set of resource attributes, and the second set of task attributes with the second set of resource attributes, wherein at least one of first and second resources is something other than equipment, manpower or workplace; and
the computer system providing the human scheduler with the proposed schedule.

2-18. (canceled)

19. The method of claim 1, wherein the first resource comprises a consumable item.

20. The method of claim 1, wherein at least one of the attributes of the first set of resource attributes comprises a preference.

21. The method of claim 20, wherein preference comprises a task preference.

22. The method of claim 20, wherein preference comprises a co-worker preference.

23. The method of claim 20, wherein preference comprises a time period preference.

24. The method of claim 1, further comprising the human scheduler using a portable device to re-schedule the task as a function of task status obtained by physically moving about a worksite.

25. The method of claim 1, further comprising using a social media computer environment to obtain information about the first resource, and utilizing the information as an attribute of the first resource to match at least one of the first set of task attributes.

26. The method of claim 1, further comprising using a tracking engine to obtain a current location of the first resource, and utilizing the current location as an attribute of the first set of task attributes, wherein the first resource is a piece of equipment.

27. The method of claim 25, wherein the tracking engine uses a sensor to determine the current location.

28. The method of claim 1, further comprising the computer system using a preloaded database to automatically determine at least two of the first set of task attributes.

29. The method of claim 1, wherein the step of producing a proposed schedule comprises initially scheduling the task.
